(19) United States
(12) Patent Application Publication
(10) Pub. No.: US 2017/0005833 A1
(43) Pub. Date: Jan. 5, 2017

(54) METHOD, SWITCH DEVICE, AND STORAGE MEDIUM

(71) Applicant: FUJITSU LIMITED, Kawasaki-shi (JP)

(72) Inventor: Shuhei NISHI, Kawasaki (JP)

(73) Assignee: FUJITSU LIMITED, Kawasaki-shi (JP)

(21) Appl. No.: 15/166,604

(22) Filed: May 27, 2016

(30) Foreign Application Priority Data
Jul. 1, 2015 (JP) 2015-132607

(51) Int. Cl. H04L 12/46; H04L 12/721; H04L 12/741; H04L 29/12

(52) U.S. Cl. CPC H04L 12/4641; H04L 61/6022; H04L 61/6068; H04L 45/72; H04L 45/74

(57) ABSTRACT

A method executed by a switch device including ports, the switch device being configured to transfer a received frame based on first corresponding information including an identifier of one of the ports and an identifier of a virtual network which are associated with one another. The method includes: receiving a first frame including an identifier of a first virtual network at a first port among the ports; determining whether the identifier of the first virtual network is stored in association with the identifier of the first port in the first corresponding information; and storing, when it is determined that the identifier of the first virtual network is not stored in association with the identifier of the first port in the first corresponding information, the identifier of the first virtual network in association with the identifier of the first port in the first corresponding information.

### CROSS-REFERENCE TO RELATED APPLICATION

This application is based upon and claims the benefit of priority of the prior Japanese Patent Application No. 2015-132607, filed on Jul. 1, 2015, the entire contents of which are incorporated herein by reference.

### FIELD

The embodiment discussed herein is related to a virtual network design technology.

### BACKGROUND

As a technology for virtually dividing a network, a virtual local area network (VLAN) has been known. Normally, VLAN setting is performed in accordance with the IEEE 802.1Q standard or the like. IEEE is an abbreviation for the Institute of Electrical and Electronic Engineers, Inc.

FIG. 1 is a diagram illustrating an example of VLAN setting in a network. In this example, a description will be given, specifically, with focus on access switches provided between an aggregate switch (there may be cases where a core switch is used), which is an upper level switch, and servers. VLAN setting of the access switches is performed so as to match VLAN setting of the aggregate switch and VLAN setting at a server side. Among ports of the access switches, for each port that is provided at an upper level switch side, both of a VLAN identifier (VID) 100 and a VID 200 are set. On the other hand, for each port that receives a frame from a network interface card (NIC) that belongs to a VLAN of the VID 100, the VID 100 is set. Among server side ports of the access switches, for each port that receives a frame from an NIC that belongs to a VLAN of the VID 200, the VID 200 is set.

When wrong setting is used for the access switches, various troubles, including a trouble in which a server and the upper level switch are disabled to perform communication therebetween, a trouble in which devices that are not supposed to be coupled to each other are coupled, and the like, occur. Therefore, a network engineer performs an operation with care so as not to perform error setting while checking an actual connection state using a command line interface (CLI) and the like. As described above, VLAN setting is an operation for which it takes much time and labor.

Regarding VLAN setting, a technology called a VLAN trunking protocol (VTP) is known. In this technology, information of a VLAN database is transferred to each switch in a domain from a device that manages VLAN information, and each switch may reflect the information of the VLAN database to the switch itself. However, also in this technology, an administrator manually selects a VID that is to be set for each port from the VLAN database and sets the selected VID. Also, the VTP is not standardized and the VTP may be used only when a network is constructed using only a network switch of a specific type.

As an example of related art, Japanese Laid-open Patent Publication No. 2005-151025 has been known.

### SUMMARY

According to an aspect of the invention, a method executed by a switch device including a plurality of ports, the switch device being configured to transfer a received frame based on first corresponding information, the first corresponding information including an identifier of one of the plurality of ports and an identifier of a virtual network which are associated with one another, the method includes: receiving a first frame including an identifier of a first virtual network at a first port among the plurality of ports; determining whether the identifier of the first virtual network is stored in association with the identifier of the first port in the first corresponding information; and storing, when it is determined that the identifier of the first virtual network is not stored in association with the identifier of the first port in the first corresponding information, the identifier of the first virtual network in association with the identifier of the first port in the first corresponding information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system including an access switch;

FIG. 2 is a functional block diagram of an access switch;

FIG. 3 is a chart illustrating an example of a frame;

FIG. 4 is a table illustrating an example of data that is stored in a learning VLAN table;

FIG. 5 is a table illustrating an example of data that is stored in a fixed VLAN table;

FIG. 6 is a table illustrating an example of data that is stored in an integrated VLAN table;

FIG. 7 is a flow chart illustrating a processing flow of processing that is executed by an access switch;

FIG. 8 is a view illustrating an example of a display screen;

FIG. 9 is a diagram illustrating an ARP;

FIG. 10 is a diagram illustrating the ARP;

FIG. 11 is a table illustrating the ARP;

FIG. 12 is a chart illustrating a processing flow of processing that is executed by an access switch;

FIG. 13 is a diagram illustrating an example of VLAN setting;

FIG. 14 is a table illustrating an example of the VLAN setting;

FIG. 15 is a table illustrating an example of the VLAN setting;

FIG. 16 is a diagram illustrating setting when a policy is “MANUAL”; and

FIG. 17 is a diagram illustrating a hardware configuration of an access switch.

### DESCRIPTION OF EMBODIMENT

According to one aspect, it is an object of this embodiment to provide a technology for performing VLAN setting on a network switch in a simple manner.

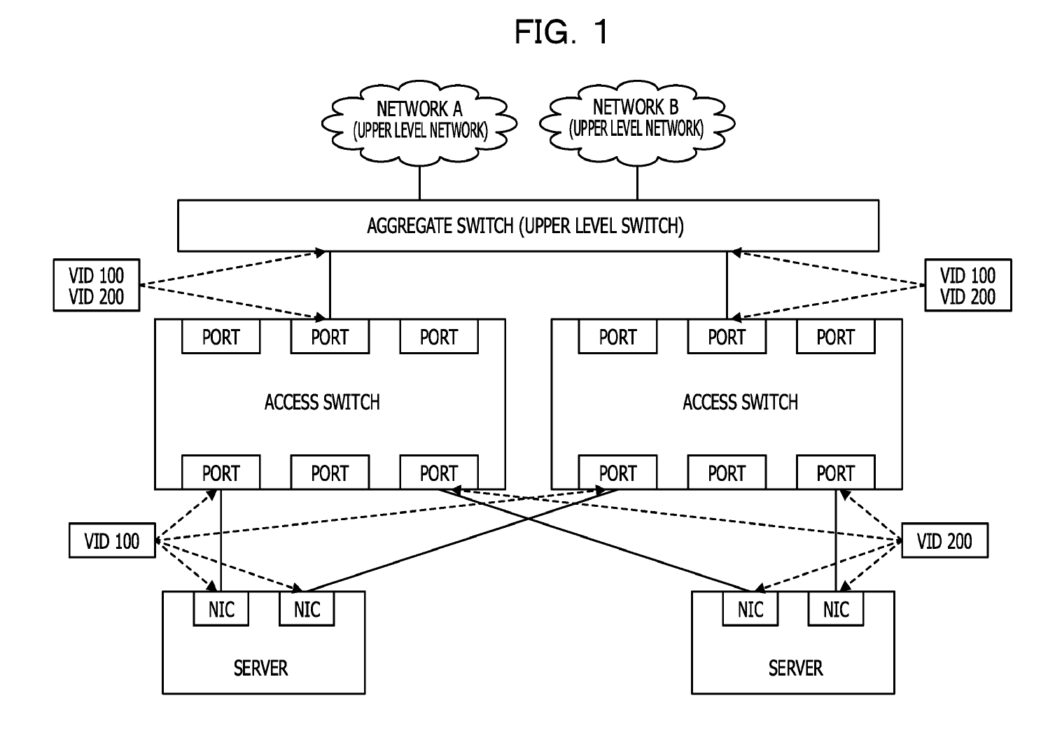

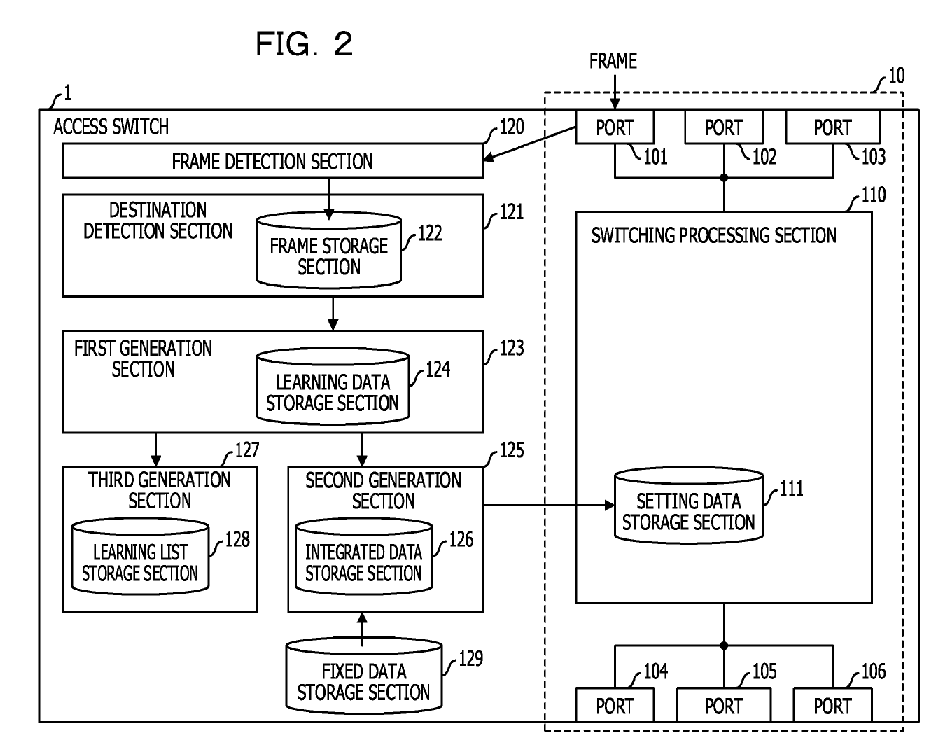

In this embodiment, a method for performing VLAN setting on an access switch in a system illustrated in FIG. 1, an example of VLAN setting, and the like are described. FIG. 2 is a functional block diagram of an access switch 1 according to this embodiment. For example, the access switch 1, which is a layer-2 switch, includes ports 101 to 106, a switching processing section 110, a setting data storage section 111, a frame detection section 120, a destination detection section 121, a frame storage section 122, a first generation section 123, a learning data storage section 124, a second generation section 125, an integrated data storage section 126, a third generation section 127, a learning list storage section 128, and a fixed data storage section 129.

In FIG. 2, frame relay is executed in a part 10 surrounded by a dashed line. For example, when the switching processing section 110 receives a frame from one of the ports 101 to 106, the switching processing section 110 determines a port, which is a transfer destination of the frame, based on a setting VLAN table in the setting data storage section 111, a media access control (MAC) address, and the like, and outputs the received frame to the port that has been determined.

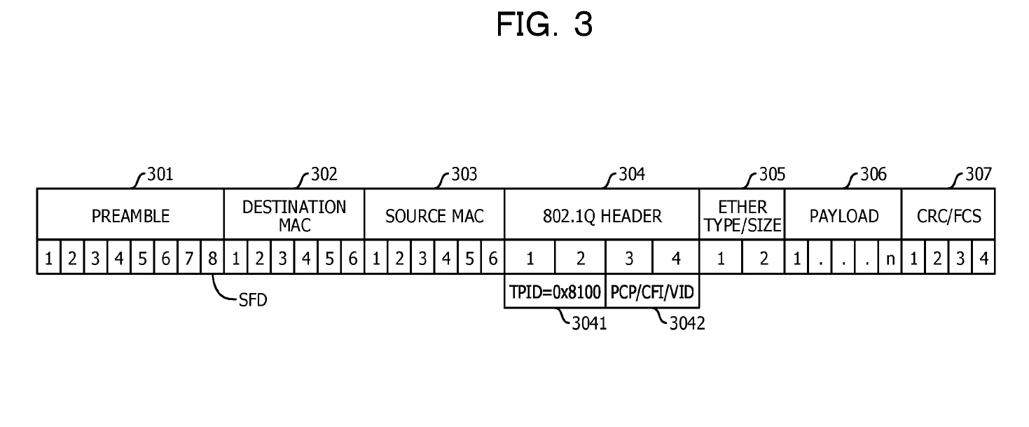

In FIG. 3, an example of a frame is illustrated. In the example of FIG. 3, a frame includes a preamble field 301, a destination MAC address field 302, a transmission source MAC address field 303, a VLAN tag field 304, an Ether type and length field 305, a payload 306, and a cyclic redundancy check (CRC) and frame check sequence (FCS) field 307. The VLAN tag field 304 includes a tag protocol identifier (TPID) field 3041, a priority code point (PCP), canonical format indicator (CFI), and VID field 3042. In this embodiment, “0x8100”, which indicates that the frame is a tagged frame in accordance with IEEE 802.1Q, is set as a TPID. The frame is, for example, a tagged frame in accordance with IEEE 802.1Q. Each field of the frame is compliant with a tagged frame format in accordance with IEEE 802.1Q, and therefore, the detailed description thereof will be omitted.

Returning to the description of FIG. 2, the frame detection section 120 detects, among frames that have been received at the ports 101 to 106, a frame that is to be detected, based on the setting VLAN table that is stored in the setting data storage section 111. Then, the frame detection section 120 stores a copy of the detected frame and the number of the port that has received the frame in the frame storage section 122. FIG. 2 illustrates an example where a frame is received at the port 101. The destination detection section 121 extracts the VID of the frame that is stored in the frame storage section 122 and outputs the extracted VID with the number of the port that has received the frame to the first generation section 123. The first generation section 123 stores the VID in association with the number of the port that has received the frame in the learning VLAN table in the learning data storage section 124. The third generation section 127 generates a learning VLAN list from the learning VLAN table that is stored in the learning data storage section 124 and stores the generated learning VLAN list in the learning list storage section 128. The second generation section 125 generates an integrated VLAN table, based on the learning VLAN table that is stored in the learning data storage section 124 and a fixed VLAN table that is stored in the fixed data storage section 129, and stores the generated integrated VLAN table in the integrated data storage section 126. Also, the second generation section 125 updates the setting VLAN table that is stored in the setting data storage section 111, based on data that is stored in the integrated VLAN table.

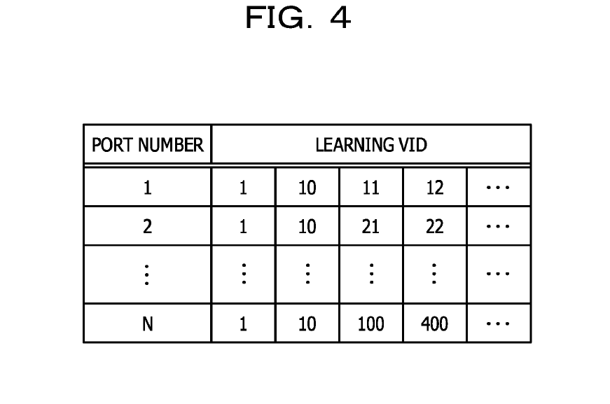

FIG. 4 is a table illustrating an example of data that is stored in a learning VLAN table. In the example of FIG. 4, a port number and a learning VID are store in the learning VLAN table. The learning VID is a VID that has been learned by processing according to this embodiment.

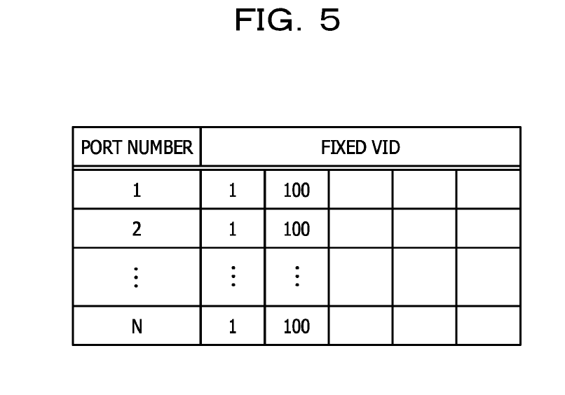

FIG. 5 is a table illustrating an example of data that is stored in a fixed VLAN table. In the example of FIG. 5, a port number and a fixed VID are stored in the fixed VLAN table. The fixed VID is a VID that has been set by a user in advance.

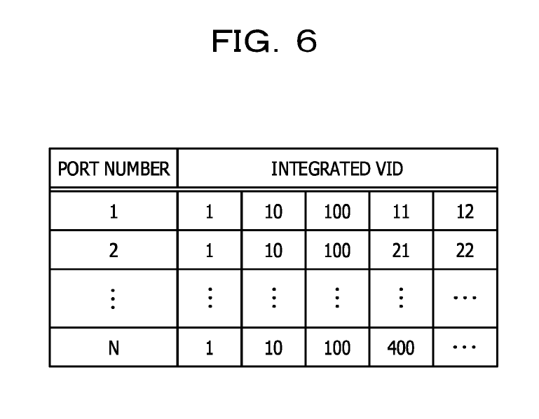

FIG. 6 is a table illustrating an example of data that is stored in an integrated VLAN table. In the example of FIG. 6, a port number and an integrated VID are stored in an integrated VLAN table. The integrated VLAN table is a table obtained by integrating a learning VLAN table and a fixed VLAN table together. Note that the contents of the setting VLAN table are basically the same as the contents of the integrated VLAN table.

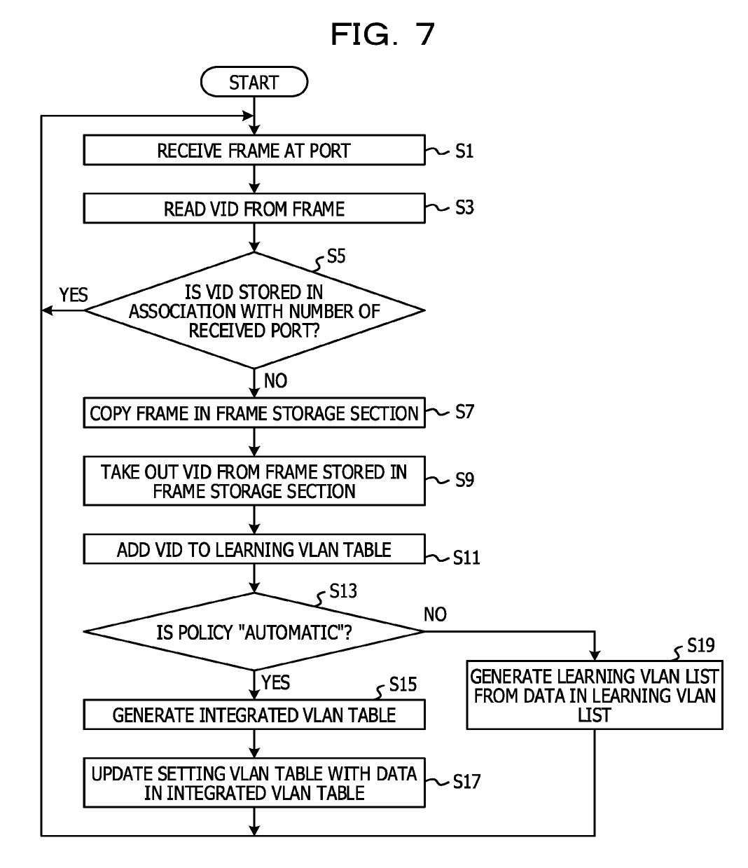

Next, with reference to FIG. 7 to FIG. 12, processing that is executed by the access switch 1 will be described. First, processing that is executed by the access switch 1 when the access switch 1 receives a frame will be described with reference to FIG. 7.

One of the ports 101 to 106 in the access switch 1 receives a frame from a network to which the port is coupled (Step S1).

The frame detection section 120 reads a VID from the frame that has been received in Step S1 (Step S3). The frame detection section 120 determines whether or not the VID (which will be hereinafter referred to as a target VID) that has been read is stored in association with the number of the port (which will be hereinafter referred to as a target port) that has received the frame in the setting VLAN table in the setting data storage section 111 (Step S5).

If the target VID is stored in association with the number of the target port in the setting VLAN table (YES in Step S5), the target VID has been already learned or has been set by a user, and therefore, the process returns to the processing of Step S1.

On the other hand, if the target VID is not stored in association with the number of the target port in the setting VLAN table (NO in Step S5), the frame detection section 120 stores a copy of the frame that has been received in Step S1 with the number of the target port in the frame storage section 122 (Step S7). Note that, although such a frame is deleted in a normal network switch, the frame is held in this embodiment.

The destination detection section 121 takes out a VID from the frame that has been stored in the frame storage section 122 in Step S7 (Step S9) and outputs the VID with the number of the target port to the first generation section 123. The VID that has been taken out in Step S9 is the same as the target VID, and therefore, the VID that has been taken out in Step S9 will be hereinafter referred to as the target VID.

The first generation section 123 stores the target VID in association with the number of the target port in the learning VLAN table that is stored in the learning data storage section 124 (Step S11).

The first generation section 123 determines whether or not a policy is “AUTOMATIC” (Step S13). The policy is information regarding whether or not automatic setting of the VID, which has been set by the administrator in advance, is to be executed. If the policy is “AUTOMATIC”, automatic setting of the VID is executed. If the policy is “MANUAL”, automatic setting of the VID is not executed.

If the policy is “AUTOMATIC” (YES in Step S13), the first generation section 123 requests the second generation section 125 to perform automatic setting of the VID. In response to the request, the second generation section 125 integrates data that is stored in the learning VLAN table and data that is stored in the fixed VLAN table together to generate an integrated VLAN table (Step S15) and stores the generated integrated VLAN table in the integrated data storage section 126.

The second generation section 125 updates the data that is stored in the setting VLAN table in the setting data storage section 111, based on the data that is stored in the integrated VLAN table (Step S17). Then, the process returns to the processing of Step S1. Thus, the VID of the VLAN to which a device that is coupled to the port belongs is automatically learned, and therefore, a VID setting operation that is to be performed by the administrator or the like is omitted. Then, relay of the frame is performed, based on the setting VLAN table to which a learning result and setting by the administrator are reflected.

On the other hand, if the policy is “MANUAL” (NO in Step S13), the first generation section 123 informs the third generation section 127 that automatic setting of a VID is not performed. Accordingly, the third generation section 127 generates a learning VLAN list from the data that is stored in the learning VLAN table (Step S19) and stores the generated learning VLAN list in the learning list storage section 128. Then, the process returns to the processing of Step S1.

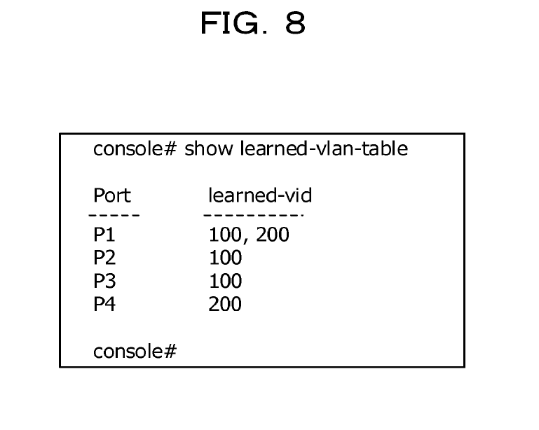

FIG. 8 is a view illustrating an example of a display screen. The administrator may check the learning VLAN list that is stored in the learning list storage section 128, for example, via the display screen illustrated in FIG. 8 and the like. In the example of FIG. 8, the identifier (which may be the number of the port) of the port and the VID that has been learned are displayed. The administrator performs an operation of changing the contents of the fixed VLAN table or the setting VLAN table with reference to the displayed contents.

As has been described, according to this embodiment, VLAN setting of the access switch 1 is automatically performed without using special device and protocol. Thus, network construction at an initial introduction may be greatly simplified. Also, in a case where a VLAN has been newly added, when VLAN setting of an upper level switch and a server is implemented by an administrator, VLAN setting of the access switch 1 is automatically performed. Furthermore, a problem in which the VLAN setting and actual setting do not match each other and thus a state where connection is disabled occurs is not caused.

When a server starts communication, the server transmits an address resolution protocol (ARP) request in a broadcast manner in order to acquire a destination MAC address. In the above-described processing, the VID may be learned by using the frame of the ARP request.

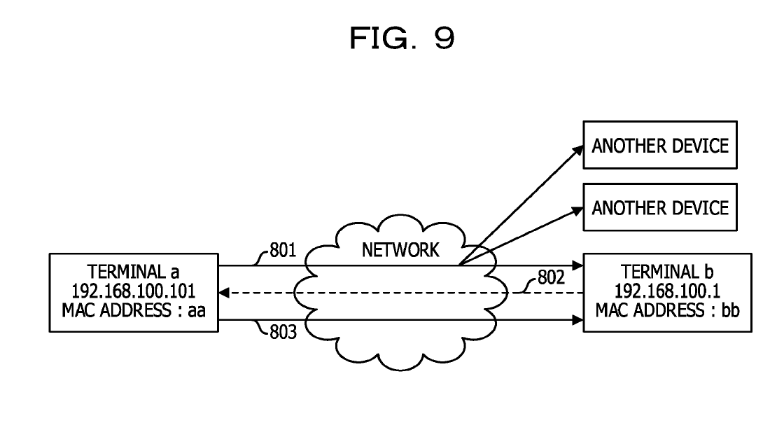

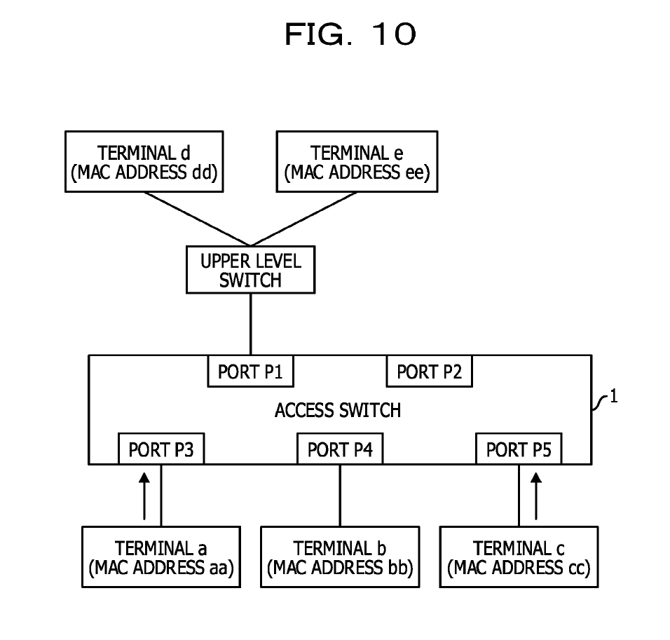

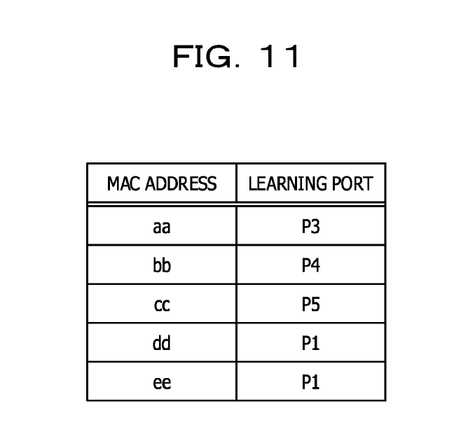

FIG. 9, FIG. 10, and FIG. 11 illustrate an ARP. With reference to FIG. 9, address resolution in accordance with a general ARP will be described. In FIG. 9, a terminal a, which has an Internet protocol (IP) address “192.168.100.101” and a MAC address “aa”, starts communication with a terminal b, which has an IP address “192.168.100.1” and a MAC address “bb”.

In this case, the terminal a broadcasts an ARP request including the IP address of the terminal b (Communication 801). When the terminal b receives the ARP request, the terminal b transmits a response to the ARP request to the terminal a (Communication 802). The response to the ARP request includes the MAC address of the terminal b. Note that a device other than the terminal b does not transmit a response to the ARP request to the terminal a. The terminal a sets the MAC address included in the response in Communication 802 in the field of the destination MAC address of the frame that is transmitted to the terminal b and transmits the field (Communication 803). Thus, the frame that has been transmitted from the terminal a is transferred to the terminal b.

FIG. 10 illustrates an example of a system. In FIG. 10, the access switch 1 includes ports P1 to P5. An upper level switch (for example, an aggregate switch or a core switch) is coupled to the port P1, the terminal a, which has the MAC address “aa”, is coupled to the port P3, the terminal b, which has the MAC address “bb”, is coupled to the port P4, and a terminal c, which has a MAC address “cc”, is coupled to the port P5. A terminal d, which has a MAC address “dd”, and a terminal e, which has a MAC address “ee”, are coupled to the upper level switch.

In this system, the MAC address table of the access switch 1 is in a state illustrated in FIG. 11. As illustrated in FIG. 11, in the MAC address table, a port identifier P3 is stored in association with the MAC address “aa”, a port identifier P4 is stored in association with the MAC address “bb”, a port identifier P5 is stored in association with the MAC address “cc”, a port identifier P1 is stored in association with the MAC address “dd”, and the port identifier P1 is stored in association with the MAC address “ee”. The MAC address table is generated for each VLAN.

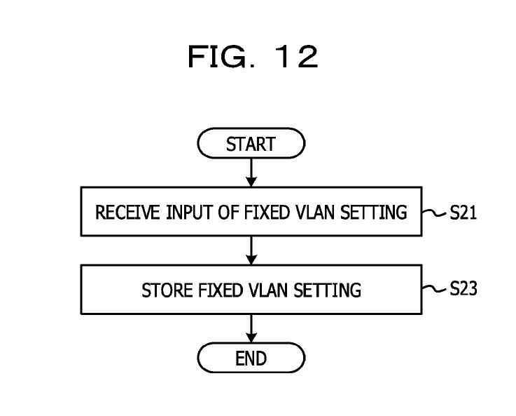

Next, with reference to FIG. 12, processing of setting a fixed VLAN table will be described. FIG. 12 is a chart illustrating a processing flow of processing that is executed by an access switch.

First, the second generation section 125 receives an input of fixed VLAN setting from the administrator (Step S21). The fixed VLAN setting includes the number of a port and a VID. Then, the second generation section 125 stores the fixed VLAN setting in the fixed VLAN table in the fixed data storage section 129 (Step S23). Then, the process ends.

Thus, VLAN setting is performed as intended by the administrator.

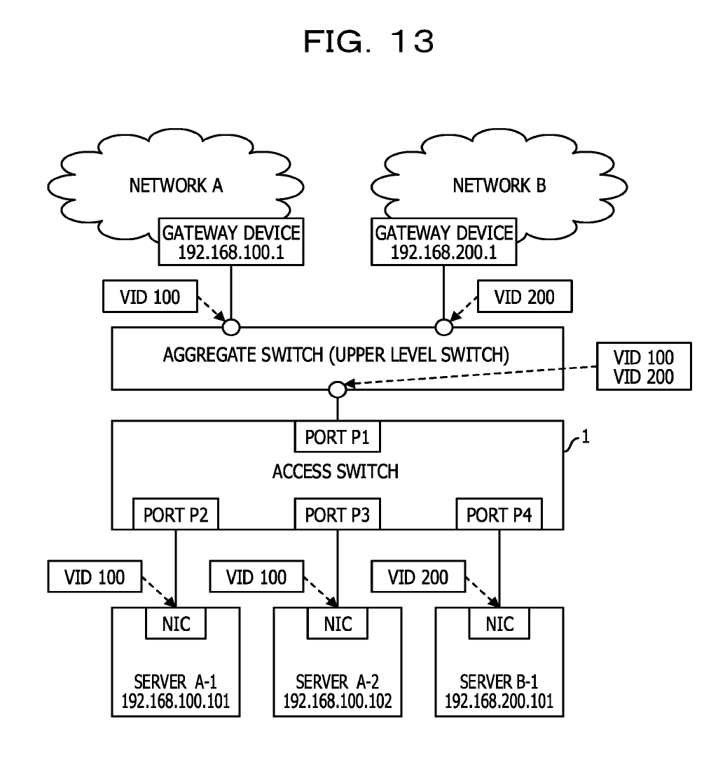

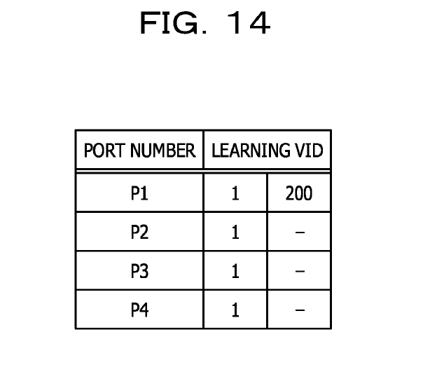

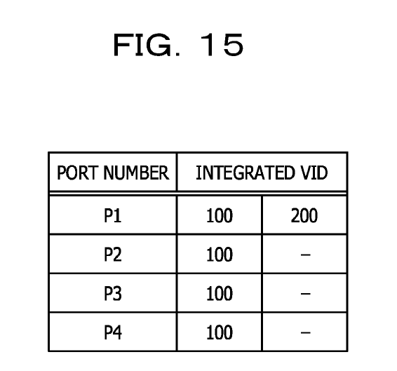

FIG. 13, FIG. 14, and FIG. 15 illustrate an example of VLAN setting. FIG. 13 illustrates an example of a system. In the example of FIG. 13, an aggregate switch (there may be cases where a core switch is used), which is an upper level switch, is coupled to the port P1 of the access switch 1, and the VID 100 and the VID 200 are set for a port of the aggregate switch, which is coupled to the port P1 of the access switch 1. The VID 100 is set for a port, among ports of the aggregate switch, which is coupled to a gateway device the IP address of which is “192.168.100.1”. The VID 200 is set for a port, among the ports of the aggregate switch, which is coupled to a gateway device the IP address is “192.168.200.1”.

A server A-1 is coupled to the port P2 of the access switch 1, a server A-2 is coupled to the port P3 of the access switch 1, and a server B-1 is coupled to the port P4 of the access switch 1. The VID 100 is set for an NIC of the server A-1 and an NIC of the server A-2, and the VID 200 is set for an NIC of the server B-1.

A device that belongs to the VLAN of the VID 100 transmits and receives a frame including the VID 100. A device that belongs to the VLAN of the VID 200 transmits and receives a frame including the VID 200.

For example, when a device that belongs to a network A starts communication with the server A-1, the gateway device (the IP address of which is “192.168.100.1”) provided at an entrance of the network A broadcasts an ARP request. Then, when the access switch 1 processes the ARP request that has been transmitted by the gateway device, communication between the gateway device and the server A-1 is enabled, so that the device that belongs to the network A and the server A-1 are enabled to exchange frames.

Data illustrated in FIG. 14 is stored in the learning VLAN table of the access switch 1. In the example of FIG. 14, the VID 100 and the VID 200 are stored for the port P1, the VID 100 is stored for the port P2 and port P3, and the VID 200 is stored for the port P4.

Also, if data is not stored in the fixed VLAN table or a VID other than the VID that is registered in the learning VLAN table is not stored in the fixed VLAN table, the integrated VLAN table of the access switch 1 is as illustrated in FIG. 15. In the example of FIG. 15, the VID 100 and the VID 200 are stored for the port P1, the VID 100 is stored for the port P2 and the port P3, and the VID 200 is stored for the port P4. That is, the learning VLAN table and the integrated VLAN table are the same.

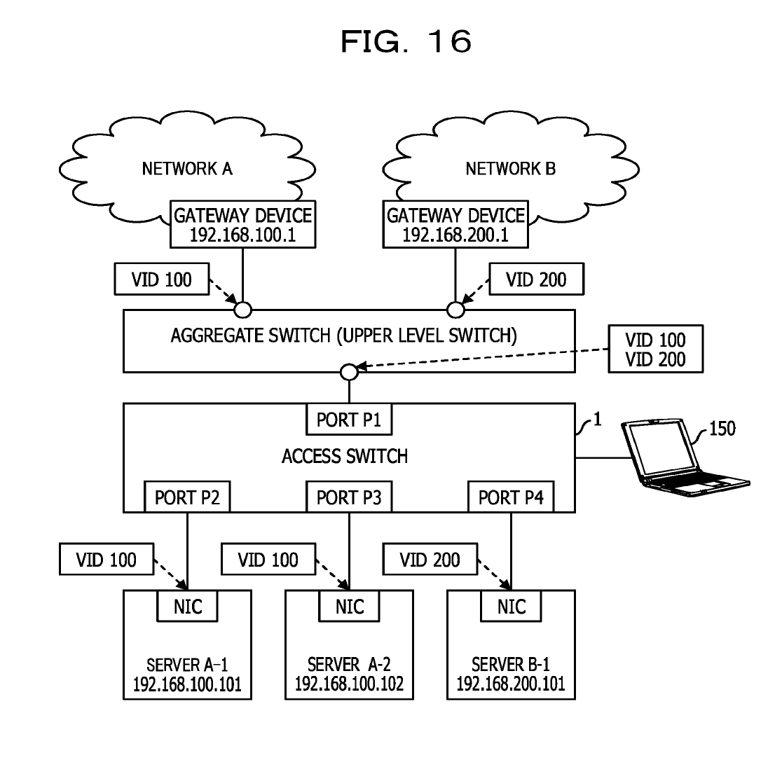

FIG. 16 is a diagram illustrating setting when a policy is “MANUAL”. If the policy is “MANUAL” and VLAN setting is not automatically performed, for example, as illustrated in FIG. 16, a terminal 150 that is operated by the administrator is coupled to the access switch 1. The administrator and the like operate the terminal 150 and checks the contents of the learning VLAN list, for example, via the display screen illustrated in FIG. 8. Then, the processing described with reference to FIG. 12 is performed, and thereby, the fixed VLAN setting is stored in the fixed VLAN table. Thus, even when automatic setting is not performed, a frame may be appropriately transferred in a network.

An embodiment of the present disclosure has been described above, but the present disclosure is not limited thereto. For example, there may be cases where the functional block of the access switch 1, which has been described above, does not match an actual program module configuration.

Also, the above-described configuration of each table is merely an example, and there may be cases where each table does not have the above-described configuration. Furthermore, in a processing flow, processing order may be changed as long as a processing result is not varied. Furthermore, one processing may be executed in parallel with other processing.

Also, if the policy is “AUTOMATIC”, a learning result may be directly written in the setting VLAN table. Then, at a timing at which the learning result is written in the setting VLAN table, data in the fixed VLAN table may be reflected to the setting VLAN table.

Also, this embodiment may be applied to a switch other than the access switch 1.

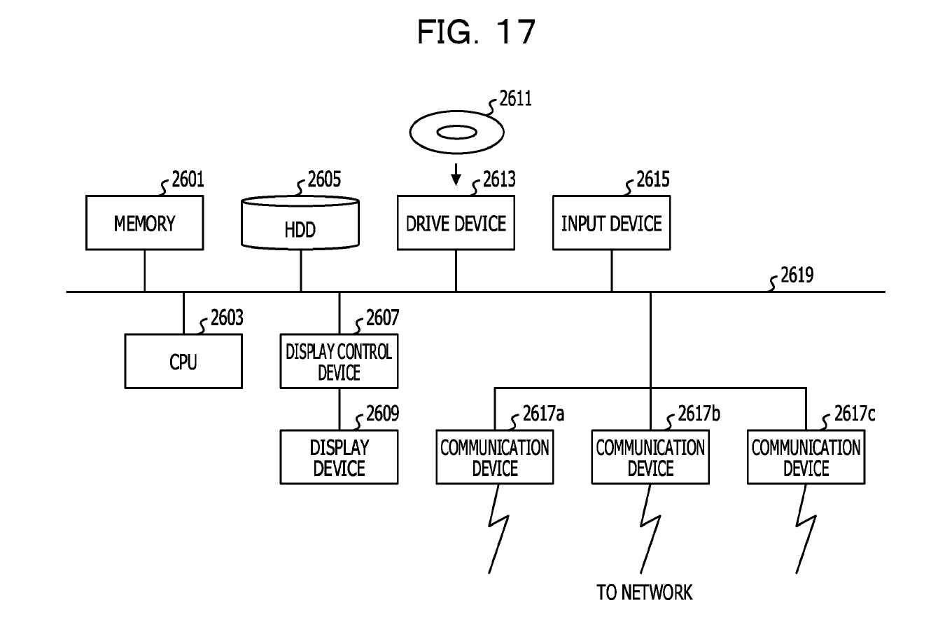

FIG. 17 is a diagram illustrating a hardware configuration of an access switch. As illustrated in FIG. 17, the above-described switch may be configured such that a memory 2601, a central processing unit (CPU) 2603, a hard disk drive (HDD) 2605, a display control device 2607 that is coupled to a display device 2609, a drive device 2613 for a removable disk 2611, an input device 2615, a communication control device 2617 (communication devices 2617a to 2617c in FIG. 17) that provides connection to a network are coupled to one another via a bus 2619. Note that the switch may have a configuration including the above-described members, except for the display control device 2607, the display device 2609, the drive device 2613, and the input device 2615. An operating system (OS) and an application program used for implementing the processing in this embodiment are stored in the HDD 2605 and, when being executed by the CPU 2603, are loaded from the HDD 2605 to the memory 2601. The CPU 2603 controls the display control device 2607, the communication control device 2617, and the drive device 2613 to cause each of the display control device 2607, the communication control devices 2617, and the drive device 2613 to perform the corresponding operation, as appropriate. Note that data that has been input via one of the communication control devices 2617 is output via another one of the communication control devices 2617. The CPU 2603 controls the communication control devices 2617 to appropriately change an output destination. Also, data that is being processed is stored in the memory 2601, and, as appropriate, is stored in the HDD 2605. In this embodiment of a technology disclosed herein, an application program used for implementing the above-described processing is stored in the computer-readable removable disk 2611 to be distributed and is installed from the drive device 2613 to the HDD 2605. There may be cases where the application program is installed in the HDD 2605 via a network, such as the Internet, and one of the communication control devices 2617. Hardware, such as the above-described CPU 2603 and memory 2601 and the like, the OS, and an appropriate application program are organically cooperate with one another, and thereby, a computer device having the above-described configuration realizes the above-described various functions.

The above-described embodiment of the present disclosure is summarized as follows.

A virtual network setting method according to this embodiment includes (A) receiving a frame that includes an identifier of a first virtual network at a first port, (B) determining whether or not the identifier of the first virtual network is stored in association with an identifier of the first port in a first data storage section that stores an identifier of a virtual network in association with an identifier of a port, and (C) storing, if the identifier of the first virtual network is not stored in accordance with the identifier of the first port in the first data storage section, the identifier of the first virtual network in accordance with the identifier of the first port in the first data storage section.

Thus, VLAN setting may be performed on a relay device in a simple manner without an operation performed by the administrator and the like.

The virtual network setting method may further include (D) receiving an input including an identifier of a port and an identifier of a virtual network and storing the identifier of the virtual network in association with the identifier of the port in a second date storage section, and (E) adding data that is stored in the second data storage section to the first data storage section. Thus, user's intension is reflected.

The virtual network setting method may further include (F) generating display data that is provided to a user, based on data that is stored in the first data storage section. Thus, when the user manually performs setting, burdens of the user are reduced and an error is not caused.

Note that a program that causes a processor to perform processing in accordance with the above-described method may be created, and the program may be stored in a computer-readable storage medium or a storage device, such as, for example, a flexible disk, a CD-ROM, an magnetooptical disk, a semiconductor memory, a hard disk, and the like. Note that intermediate processing results are temporarily held in a storage device, such as a main memory and the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method executed by a switch device including a plurality of ports, the switch device being configured to transfer a received frame based on first corresponding information, the first corresponding information including an identifier of one of the plurality of ports and an identifier of a virtual network which are associated with one another, the method comprising:
receiving a first frame including an identifier of a first virtual network at a first port among the plurality of ports;
determining whether the identifier of the first virtual network is stored in association with the identifier of the first port in the first corresponding information; and
storing, when it is determined that the identifier of the first virtual network is not stored in association with the identifier of the first port in the first corresponding information, the identifier of the first virtual network in association with the identifier of the first port in the first corresponding information.

2. The method according to claim 1, wherein
the first corresponding information in which the identifier of the first virtual network is stored in association with the identifier of the first port is referred to in transfer control that is performed on another frame that is received by the switch device.

3. The method according to claim 1, further comprising:
receiving an input including an identifier of a port and an identifier of a virtual network;
storing the received identifier of the virtual network in association with the received identifier of the port, in second corresponding information that is different from the first corresponding information; and
adding data stored in the second corresponding information to the first corresponding information.

4. The method according to claim 1, further comprising:
generating display data for providing to a user based on data stored in the first corresponding information.

5. The method according to claim 1, wherein
the storing includes referring to policy information related to the storing,
when the policy information indicates first information, the storing stores the identifier of the first virtual network in association with the identifier of the first port in the first corresponding information in response to an operation performed by a user, and
when the policy information indicates the second information, the storing stores the identifier of the first virtual network in association with the identifier of the first port in the first corresponding information without the operation of the user.

6. A switch device configured to transfer a received frame based on first corresponding information, the switch device comprising:
a plurality of ports including a first port;
a memory configured to the first corresponding information, the first corresponding information including an identifier of one of the plurality of ports and an identifier of a virtual network which are associated with one another; and
a processor coupled to the memory and configured to:
determine whether an identifier of a first virtual network in a first frame received at the first port is stored in association with the identifier of the first port in the first corresponding information, and
store, when it is determined that the identifier of the first virtual network is not stored in association with the identifier of the first port in the first corresponding information, the identifier of the first virtual network in association with the identifier of the first port in the first corresponding information.

7. The switch device according to claim 6, wherein
the first corresponding information in which the identifier of the first virtual network is stored in association with the identifier of the first port is referred to in transfer control that is performed on another frame that is received by the switch device.

8. The switch device according to claim 7, wherein the processor is configured to:
receive an input including an identifier of a port and an identifier of a virtual network,
store the received identifier of the virtual network in association with the received identifier of the port in second corresponding information that is different from the first corresponding information, and
add data stored in the second corresponding information to the first corresponding information.

9. The switch device according to claim 7, wherein the processor is configured to:
generate display data for providing to a user based on data stored in the first corresponding information.

10. The switch device according to claim 7, wherein the processor is configured to:
refer to policy information,
when the policy information indicates first information, store the identifier of the first virtual network in association with the identifier of the first port in the first corresponding information in response to an operation performed by a user, and
when the policy information indicates the second information, store the identifier of the first virtual network in association with the identifier of the first port in the first corresponding information without the operation of the user.

11. A non-transitory storage medium storing a program for causing a switch device including a plurality of ports to execute a process, the switch device being configured to transfer a received frame based on first corresponding information, the first corresponding information including an identifier of one of the plurality of ports and an identifier of a virtual network which are associated with one another, the process comprising:
receiving a first frame including an identifier of a first virtual network at a first port among the plurality of ports;
determining whether the identifier of the first virtual network is stored in association with the identifier of the first port in the first corresponding information; and
storing, when it is determined that the identifier of the first virtual network is not stored in association with the identifier of the first port in the first corresponding information, the identifier of the first virtual network in association with the identifier of the first port in the first corresponding information.

12. The storage medium according to claim 11, wherein
the first corresponding information in which the identifier of the first virtual network is stored in association with the identifier of the first port is referred to in transfer control that is performed on another frame that is received by the switch device.

13. The storage medium according to claim 11, wherein the process further comprises:
receiving an input including an identifier of a port and an identifier of a virtual network;
storing the received identifier of the virtual network in association with the received identifier of the port, in second corresponding information that is different from the first corresponding information; and
adding data stored in the second corresponding information to the first corresponding information.

14. The storage medium according to claim 11, wherein the process further comprises:
generating display data for providing to a user based on data stored in the first corresponding information.

15. The storage medium according to claim 11, wherein
the storing includes referring to policy information related to the storing,
when the policy information indicates first information, the storing stores the identifier of the first virtual network in association with the identifier of the first port in the first corresponding information in response to an operation performed by a user, and
when the policy information indicates the second information, the storing stores the identifier of the first virtual network in association with the identifier of the first port in the first corresponding information without the operation of the user.
